(19) United States
(12) Patent Application Publication
(10) Pub. No.: US 2026/0187571 A1
(43) Pub. Date: Jul. 2, 2026

(54) SYSTEM, METHOD, AND COMPUTER-READABLE MEDIUM FOR ASSESSING AND RATIONALIZING TECHNICAL DEBT USING AI AND MACHINE LEARNING ANALYSIS WITH MULTI-SOURCE DATA INTEGRATION

(71) Applicant: TEACHERS INSURANCE AND ANNUITY ASSOCIATION OF AMERICA, New York, NY (US)

(72) Inventors: Sastry VSM Durvasula, Phoenix, AZ (US); Swatee Singh, Livingston, NJ (US); Rares Ioan Almasan, Paradise Valley, AZ (US); Sonam Jha, Skillman, NJ (US); Sriram Venkatesan, Princeton Junction, NJ (US); Geeta Pyne, San Jose, CA (US); Thomas Matthew Verutes, Rockville Centre, NY (US)

(21) Appl. No.: 19/007,460

(22) Filed: Dec. 31, 2024

(51) Int. Cl. G06Q 10/0639

(52) U.S. Cl. CPC G06Q 10/06395

(57) ABSTRACT

A computing system assesses and rationalizes technical debt by collecting data, processing it with AI and learning algorithms, generating actions for asset rationalization, and producing detailed reports and AI-enabled videos. A method involves collecting data, processing with AI, generating rationalization actions, and creating reports and videos. A computer-readable medium includes instructions for performing the method of assessing and rationalizing technical debt.

### FIELD OF THE INVENTION

The present aspects relate to computing systems and methods for assessing and rationalizing technical debt, and more particularly, to utilizing artificial intelligence techniques for processing data and generating rationalization actions for software and hardware assets, such as employing neural networks and deep learning algorithms to analyze data from multiple sources and generate detailed rationalization actions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Technical debt has become an increasing concern for organizations as they scale and evolve, particularly in fast-paced technological environments. The accumulation of technical debt can significantly hinder an organization's ability to maintain and upgrade its systems efficiently, leading to increased costs and reduced system reliability over time. Traditional methods for managing technical debt often involve processes that are not only time-consuming but also require extensive programming, making the identification, quantification, and rationalization of technical debt a complex and challenging task.

In recent years, there has been a growing interest in leveraging artificial intelligence (AI) and machine learning (ML) technologies to enhance various technical processes. Despite this interest, the application of AI and ML to specifically address technical debt in both software and hardware assets remains underexplored. Current approaches generally lack the sophistication needed to automate and optimize the assessment and rationalization of technical debt, relying instead on ad hoc programming. Moreover, these methods often do not incorporate a complete range of data inputs, such as internal organizational information, industry insights, and historical assessments, which may be critical for making informed decisions regarding technical debt management.

Thus, there are significant opportunities for improved platforms and technologies for solving the identified conventional problems.

### BRIEF SUMMARY OF THE INVENTION

In one aspect, a computing system for assessing and rationalizing technical debt includes: (1) a processor; and (2) a memory that includes computer-executable instructions that, when executed, cause the computing system to: (a) collect data from multiple sources including internal organization information, technology and business industry insights, previous technical debt assessments, and business capabilities; (b) process the collected data using a combination of neural networks, generative artificial intelligence models, deep learning algorithms, and reinforcement learning with human feedback; (c) generate one or more actions for asset rationalization of software and hardware assets based on the processing; and (d) generate outputs including detailed reports, process diagrams, and artificial intelligence-enabled videos to explain one or more steps for asset rationalization.

In another aspect, a computer-implemented method for assessing and rationalizing technical debt includes: (1) collecting data from multiple sources including internal organization information, technology and business industry insights, previous technical debt assessments, and business capabilities; (2) processing the collected data using a combination of neural networks, generative artificial intelligence models, deep learning algorithms, and reinforcement learning with human feedback; (3) generating one or more actions for asset rationalization of software and hardware assets based on the processing; and (4) generating outputs including detailed reports, process diagrams, and artificial intelligence-enabled videos to explain one or more steps for asset rationalization.

In yet another aspect, a computer-readable medium includes instructions that when executed cause a computer to perform a method for assessing and rationalizing technical debt, the method includes: (1) collecting data from multiple sources including internal organization information, technology and business industry insights, previous technical debt assessments, and business capabilities; (2) processing the collected data using a combination of neural networks, generative artificial intelligence models, deep learning algorithms, and reinforcement learning with human feedback; (3) generating one or more actions for asset rationalization of software and hardware assets based on the processing; and (4) generating outputs including detailed reports, process diagrams, and artificial intelligence-enabled videos to explain one or more steps for asset rationalization.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a computing environment designed to assess and rationalize technical debt using artificial intelligence, incorporating various modules for data collection, analysis, and rationalization actions, and including a processor, memory, and network interface controller for operation according to some aspects.

FIG. 2 depicts a flow diagram of a computer-implemented method for optimizing business processes and decisions related to technology assets, according to some aspects.

FIG. 3 depicts a computer-implemented method for processing and generating reports based on internal information using artificial intelligence, according to some aspects.

FIG. 4 depicts a computer-implemented method for providing technology industry insights, according to some aspects.

FIG. 5 depicts a computer-implemented method for providing business industry insights, according to some aspects.

FIG. 6 depicts a computer-implemented method for enhancing business capabilities, according to some aspects.

FIG. 7 depicts a computer-implemented method for asset rationalization, according to some aspects.

FIG. 8 depicts a computer-implemented method for generating and utilizing synthetic data, according to some aspects.

FIG. 9A depicts an output related to a computer-implemented method for asset rationalization, according to some aspects.

FIG. 9B depicts a computer-implemented method 950 for assessing and rationalizing technical debt, according to some aspects.

FIG. 10A depicts a block-flow diagram outlining a method for assessing and managing technical debt through an artificial intelligence model, particularly a language learning model (LLM), according to some aspects.

FIG. 10B illustrates a transformer-based model architecture for processing tokenized training text, according to some aspects.

### DETAILED DESCRIPTION

In the rapidly evolving landscape of technology, organizations are increasingly confronted with the challenge of managing and updating their software and hardware assets efficiently. This challenge is compounded by the accumulation of technical debt, a concept that refers to the future cost incurred when immediate, easy solutions are chosen over better, more time-consuming alternatives. The accumulation of technical debt can significantly hinder an organization's ability to innovate and respond to market changes, leading to increased costs and reduced system efficiency and reliability. Recognizing the critical need for a more streamlined and effective approach to managing technical debt, a system has been developed that leverages the power of artificial intelligence (AI) to automate and enhance the process of assessing, quantifying, and rationalizing technical debt.

This system represents a significant advancement in the field of software and hardware asset management. By integrating a variety of data inputs, including internal organization information, technology and business industry insights, previous technical debt assessments, and business capabilities, the system offers a solution to the pervasive problem of technical debt. The present techniques may include neural networks, generative AI models, deep learning algorithms, and reinforcement learning with human feedback to analyze data, generate insightful reports, and recommend actionable steps for asset rationalization, encompassing both software and hardware assets. The system's adaptability and potential for licensing across different industries underscore its versatility and broad applicability.

One of the most notable improvements introduced by this system is the enhancement of processing capabilities. By employing advanced neural networks and deep learning algorithms, the system can process vast amounts of data from diverse sources with speed and accuracy. This includes internal organization information, technology and business industry insights, previous technical debt assessments, and business capabilities. This capability not only accelerates the assessment of technical debt but also ensures that the recommendations for asset rationalization are based on a thorough and nuanced understanding of the data. The use of generative AI models further enriches this process by enabling the creation of synthetic data and adversarial networks, which are instrumental in testing and validating the recommended frameworks. This approach ensures that the system's recommendations are robust, reliable, and tailored to the specific needs of the organization.

Another significant improvement is the optimization of network usage. The system's intelligent design allows for efficient data collection and analysis, minimizing the need for extensive data transfers and reducing network load. This optimization is particularly beneficial for organizations with complex asset portfolios and substantial technical debt, as it enables the system to operate efficiently without imposing additional strain on the organization's network infrastructure. The use of reinforcement learning with human feedback further enhances this aspect by allowing the system to refine its analysis and recommendations based on outcomes and expert input, thereby ensuring that network resources are utilized in the most effective manner possible.

Furthermore, the system introduces substantial improvements in memory usage. Through the strategic employment of algorithms, such as Long Short-Term Memory (LSTM) and Prophet for forecasting with seasonality, the system can predict timelines for asset rationalization and technical debt reduction with remarkable efficiency. This predictive capability not only aids in the strategic planning of asset updates and replacements but also optimizes memory allocation by ensuring that data storage and processing are conducted in a manner that maximizes system performance. The system's ability to generate detailed reports, process diagrams, and AI-enabled videos further exemplifies its efficient use of memory, as these outputs are designed to be both informative and compact, facilitating easy access and interpretation by stakeholders.

By harnessing the capabilities of artificial intelligence and machine learning, the system offers a scalable, efficient, and effective solution to the challenges posed by technical debt. Its improvements in processing capabilities, network usage, and memory usage not only enhance the system's performance but also provide organizations with the tools they need to make informed decisions, reduce costs, and improve overall system efficiency and reliability.

The present techniques may include artificial intelligence (AI) techniques for automating and enhancing decision-making processes involved in assessing and rationalizing technical debt. This system represents a significant advancement in the field of software and hardware asset management, offering a methodical approach to identifying, quantifying, and addressing technical debt through the utilization of AI and machine learning algorithms. The system is structured to collect data from a variety of sources, analyze this data through AI models, and generate actionable insights for asset rationalization, ultimately producing outputs that facilitate understanding and implementation of these actions.

The present asset rationalization framework may be used to a wide array of technology assets within an organization can be effectively managed to ensure they align with business objectives and operational efficiency. These assets include software applications, such as Customer Relationship Management (CRM) systems and Enterprise Resource Planning (ERP) systems, which may be crucial for day-to-day business operations. Operating systems that run on various organizational devices may be also managed to maintain security and efficiency. Networking equipment, including routers, switches, and firewalls, may be rationalized to ensure optimal communication and security within the organization's network. Servers and storage devices may be assessed for their performance, capacity utilization, and energy efficiency to make informed decisions about upgrades or decommissioning. Desktops and laptops used by employees may be managed to provide reliable and efficient computing resources. Mobile devices, which have become essential for business communications and operations, may be included to ensure they may be up-to-date and secure. Cloud services, representing a significant portion of modern IT infrastructure, may be evaluated to eliminate unused or underutilized services and to ensure the services in use best meet the organization's needs. Lastly, Internet of Things (IoT) devices, increasingly adopted for a variety of applications, may be managed to secure and optimize their use within the organization. Through this framework, organizations can streamline their technology assets, enhancing security, reducing costs, and ensuring that these assets continue to support the organization's strategic goals effectively.

### Exemplary Computing Environment

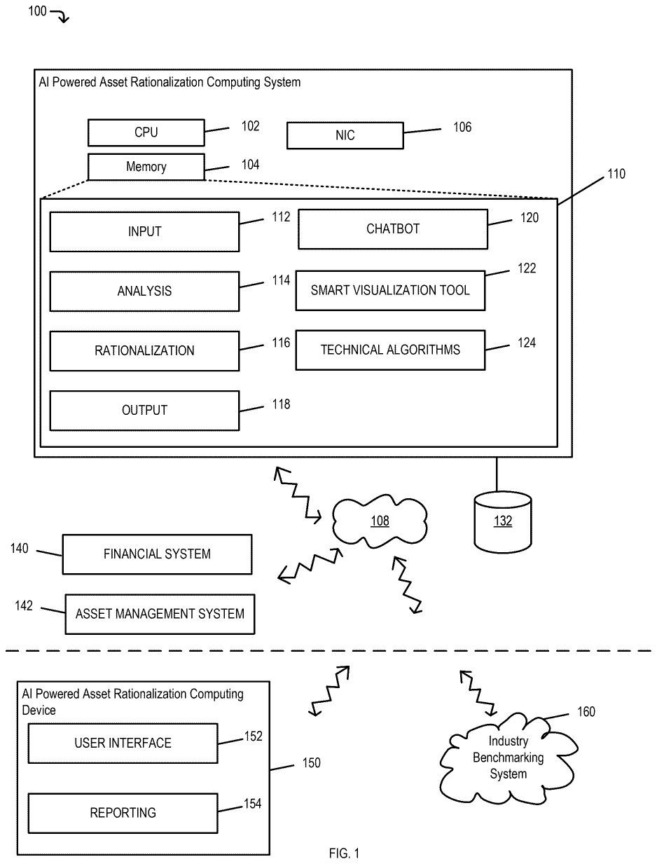

FIG. 1 describes a computing environment for assessing and rationalizing technical debt using artificial intelligence, according to some aspects. The computing environment 100 is designed to streamline the process of identifying, quantifying, and addressing technical debt by leveraging AI to automate and enhance decision-making processes. The computing environment 100 incorporates inputs from internal organization information, technology and business industry insights, previous tech debt assessments, and business capabilities to analyze data, generate reports, and recommend actions for asset rationalization, which includes both software and hardware assets.

In some aspects, the computing environment 100 includes a processor 102, a memory 104, and a network interface controller (NIC) 106. The processor 102 may include any number of processors and/or processor types, such as central processing units (CPUs), graphics processing units (GPUs), and others, configured to execute software instructions stored in the memory 104. The memory 104 may include volatile and/or non-volatile memory, such as random access memory (RAM), read-only memory (ROM), and others, having stored thereon one or more sets of computer-executable instructions.

The memory 104 includes a plurality of modules, each being a respective set of computer-executable instructions. For example, an Input Module 112 collects data from multiple sources, including internal organization information, technology and business industry insights, and previous tech debt assessments. An Analysis Module 114 utilizes neural networks and generative AI models to process the collected data. A Rationalization Module 116 recommends actions for asset rationalization based on the processing. An Output Module 118 generates detailed reports, process diagrams, and AI-enabled videos to explain the recommended steps for asset rationalization. Additional modules include a Chatbot Module 120 for interactive queries related to the actions for asset rationalization, a Smart Visualization Tool Module 122 for interactive exploration of the actions, and a Technical Algorithms Module 124 employing specific algorithms including Long Short-Term Memory (LSTM) and Prophet for forecasting with seasonality.

In the application concerning the computing environment 100 for assessing and rationalizing technical debt, the term “actions” may refer to the specific recommendations generated by the system to address and manage technical debt within an organization's array of technology assets. These actions are the outcome of analysis of data collected from various sources, processed and interpreted through artificial intelligence and machine learning algorithms. The environment 100 identifies opportunities for improving the management of technology assets and suggests actionable steps that can be taken to enhance efficiency, reduce costs, and align technology assets with the organization's strategic objectives. Actions may include recommendations for updating or upgrading software and hardware, replacing outdated or inefficient assets, retiring assets that are no longer needed or cost-effective, consolidating similar assets to streamline operations, and other strategic moves aimed at optimizing the technology asset portfolio. These actions are designed to help organizations make informed decisions that contribute to the overall health and effectiveness of their technology infrastructure, ultimately leading to a reduction in technical debt and an improvement in system efficiency and reliability.

The actions recommended by the computing environment 100 are primarily communicated in natural language within the outputs generated by the system, such as detailed reports, process diagrams, and AI-enabled videos. These natural language descriptions are designed to be easily understandable by stakeholders, enabling them to grasp the rationale behind each recommendation and how it contributes to the overall strategy for managing technical debt and optimizing technology assets. However, in addition to natural language descriptions, the actions may also be represented through other formats that facilitate understanding and implementation. For example, process diagrams visually map out the steps involved in executing a recommended action, providing a clear, step-by-step guide. Similarly, AI-enabled videos can offer dynamic and engaging explanations of the actions, further enhancing comprehension. Furthermore, in some cases, the actions could be accompanied by or translated into specific technical specifications, configuration changes, or scripts that IT professionals can directly apply to manage the technology assets. This blend of natural language explanations with actionable technical details advantageously ensures that the recommendations are both accessible to decision-makers and practical for implementation by technical teams.

The NIC 106 facilitates bidirectional networking over the network between the computing environment 100 and external data sources, customer interfaces, and other systems necessary for operation. The network may be a single communication network or may include multiple communication networks of one or more types, such as the Internet, local area networks (LANs), and wide area networks (WANs).

In the computing environment 100, designed for assessing and rationalizing technical debt with the assistance of artificial intelligence, several modules work together, each with its own set of capabilities. The input module 112 may include instructions that gather data from various sources, including internal organization information, technology and business industry insights, and data from previous technical debt assessments. This module serves as the initial point for collecting the necessary data for further processing. The analysis module 114 may include instructions that process the data collected by the input module 112. It is capable of employing neural networks and generative AI models to process the collected information, potentially identifying patterns and insights within the data. Following the analysis, the rationalization module 116 may include instructions that utilize the insights provided by the analysis module 114 to formulate recommendations for asset rationalization. These recommendations might suggest whether assets should be updated, replaced, or retired, aiming to optimize the organization's technology asset portfolio based on the processing. To communicate the findings and recommendations, the output module 118 may include instructions that generate various outputs, such as detailed reports, process diagrams, and AI-enabled videos. These outputs are designed to explain the recommended steps for asset rationalization in a manner that is accessible to stakeholders across the organization. For stakeholders seeking further information or clarification on the recommended actions, the chatbot module 120 include instructions that offer an interactive platform for queries. This module can provide responses to inquiries related to the actions for asset rationalization, enhancing user engagement. Additionally, the smart visualization tool module 122 may include instructions that provide a platform for interactive exploration of the recommended actions for asset rationalization. This module allows users to engage with the recommendations, enabling them to compare options and assess the potential impact of different strategies. Lastly, the technical algorithms module 124 may include instructions that employ algorithms, such as Long Short-Term Memory (LSTM) and Prophet, for forecasting with seasonality. This module has the capability to predict timelines for asset rationalization and technical debt reduction, incorporating temporal factors into the decision-making process.

For example, implementing LSTM (Long Short-Term Memory) and/or Prophet models may require a structured approach, starting from data preparation to model training and prediction. In the context of the present asset rationalization techniques within the computing environment 100, the implementation of an LSTM model could be particularly useful for forecasting the future performance or utilization of technology assets based on historical data. For instance, by analyzing time series data of asset usage, maintenance frequency, and performance metrics, the LSTM model may predict when an asset is likely to become less efficient or more costly to maintain. This predictive capability allows organizations to proactively make decisions about updating, replacing, or retiring assets before they become liabilities or disrupt business operations. For example, an organization could use the LSTM model to analyze historical data on server utilization, including CPU load, memory usage, and network traffic over time. By feeding this data into the LSTM model, the organization may forecast future utilization trends and identify servers that are likely to become underutilized or overburdened. This insight enables the rationalization module 116 to recommend actions such as consolidating underutilized servers or upgrading overburdened ones to ensure optimal performance and cost-efficiency. Through this approach, the LSTM model contributes to a data-driven asset rationalization process, helping organizations maintain an efficient and effective technology infrastructure.

In the asset rationalization process facilitated by the computing environment 100, the Prophet model could serve as a powerful tool for identifying seasonal patterns and trends in asset performance or demand that might not be immediately apparent. By leveraging Prophet's ability to handle time series data with strong seasonal effects, organizations can gain insights into how different assets are utilized throughout the year, enabling more informed decisions regarding asset management. For instance, consider an organization that relies heavily on certain software applications for its peak business periods, which may vary seasonally. By applying the Prophet model to usage data of these applications, the organization could predict future demand peaks with greater accuracy. This predictive insight would allow the rationalization module 116 to make recommendations on whether to scale up resources temporarily during expected high-demand periods or to invest in more permanent solutions based on long-term trends. Consequently, the Prophet model aids in optimizing the allocation of resources and ensuring that the organization's technology assets are aligned with its operational needs, thereby enhancing overall efficiency and reducing unnecessary expenditures.

In operation, the computing environment 100 serves as an autonomous system that takes proactive and prescriptive actions to assess and rationalize technical debt. It operates by collecting data from various sources, processing the data using AI and machine learning algorithms, generating actions for asset rationalization, and producing outputs to explain one or more steps for asset rationalization. Users can interact with the system through a chatbot for queries related to the actions for asset rationalization and use a smart visualization tool for interactive exploration of the actions. The system employs adversarial networks for A/B testing to validate frameworks and uses synthetic data to test the effectiveness and efficiency of different models for asset rationalization. It also employs specific algorithms, including LSTM and Prophet, for forecasting with seasonality to predict timelines for asset rationalization and technical debt reduction. This approach enables organizations to make informed decisions quickly, potentially saving costs and improving system efficiency and reliability.

In the practical application of the computing environment 100, IT managers and decision-makers within organizations (for example) may utilize the system to streamline the management of their technology assets. By leveraging the input module 112 to aggregate data from internal and external sources, these professionals may gain a view of their current technology landscape. The analysis module 114 then processes this data, employing advanced AI techniques to uncover actionable insights. This enables IT managers to understand the implications of their technical debt and identify opportunities for asset rationalization. Through the rationalization module 116, the system may recommend specific actions, such as updating outdated software or consolidating underutilized servers, thereby optimizing the organization's technology asset portfolio.

Further, financial analysts within the organization may use the computing environment 100 to evaluate the financial impact of technical debt and the proposed rationalization actions. By interacting with the chatbot module 120, they can query the system for detailed financial projections and cost-benefit analyses related to asset rationalization recommendations. The smart visualization tool module 122 allows these analysts to visually explore different rationalization scenarios and their potential financial outcomes, aiding in strategic planning and budget allocation.

Additionally, the system may find application in the hands of operational teams responsible for the day-to-day management of technology assets. These teams may use the output module 118 to access detailed reports and process diagrams that guide the implementation of recommended rationalization actions. The technical algorithms module 124, employing forecasting algorithms like LSTM and Prophet, may provide these teams with predictive insights into asset performance and utilization trends. This helps operational teams plan maintenance schedules, prepare for capacity upgrades, and ensure that the organization's technology assets remain aligned with its operational needs and strategic goals.

The computing environment 100 may include an electronic database 132. The electronic database 132 may include records of technology assets, including software and hardware specifications, usage logs, maintenance histories, cost information, and technical debt assessments. It may be a structured storage system optimized for high-speed data retrieval, analysis, and reporting, supporting the system's AI-driven processes for asset rationalization.

The implementation of the database 132 within the computing environment 100 can be tailored to meet the specific needs of asset rationalization through various database technologies and architectures. For any given aspects, the database implementation may take into account data shape, transaction volumes, scalability requirements, and analytical needs. A relational database management system like MySQL or PostgreSQL may be employed, in some aspects. A NoSQL database such as MongoDB or Apache Cassandra may be used in some aspects. Other databases such as Redis may be used. Cloud-based database services, such as Amazon RDS or Google Cloud SQL may also be used. In general, one or more components of the computing environment 100 may be implemented in the cloud, leveraging the vast array of resources and services offered by cloud computing platforms. This approach provides several advantages, including scalability, flexibility, and cost-efficiency. By deploying the computing environment 100 in the cloud (e.g., a public cloud, a private cloud, a hybrid cloud, or a combination thereof), organizations can easily scale their asset rationalization processes up or down based on their current needs, without the need for significant upfront investment in physical hardware.

The computing environment 100 may include a financial system 140 and an asset management system 142. The financial system 140 may be a module or integrated software solution designed to manage the financial aspects of asset rationalization, including cost analysis, budgeting, and forecasting. It may facilitate the evaluation of financial implications of various rationalization actions, such as the costs associated with upgrading, replacing, or retiring assets, and the potential savings or return on investment. The financial system 140 may also interface with other components of the computing environment 100 to provide real-time financial data, supporting informed decision-making based on both technical and financial criteria.

The asset management system 142 may be a module or platform that maintains records of the organization's technology assets, including hardware and software inventories, asset lifecycle information, and usage data. It may serve as a central repository for detailed asset information, enabling the computing environment 100 to assess the current state of assets, track their performance over time, and identify opportunities for rationalization. The asset management system 142 may also support the implementation of recommended rationalization actions by providing insights into asset dependencies, facilitating the planning and execution of changes to the technology asset portfolio. Both of the financial system 140 and asset management system 142 may serve as internal sources of data for the input data module 112. In some aspects, the computing environment 100 may interface with other components or modules that explicitly handle integration with existing IT infrastructure and business systems within an organization. This may include APIs or middleware designed to facilitate data exchange between the computing system and other systems, such as ERP (Enterprise Resource Planning), CRM (Customer Relationship Management), and ITSM (IT Service Management) platforms.

The 100 may interface with user interface (UI) and reporting tools. These tools may allow users to interact with the computing environment 100, customize analyses, and generate tailored reports and dashboards that align with their specific needs and decision-making processes. For example, the 100 may be communicatively coupled to an AI Powered Asset Rationalization Computing Device 150 and an industry benchmarking system 160. The device 150 may include a user interface module 152 and a reporting module 154. The user interface module 152 may include computer-executable instructions that, when executed, cause the device 150 to receive input data via users, configure settings, and navigate through various functionalities of the computing environment 100. This module may cause a graphical interface to be displayed via a display device of the device 150, that simplifies the interaction with complex data and analytical processes, making the computing environment 100 accessible to users with varying levels of technical expertise. The reporting module 154 may include computer-executable instructions that, when executed, cause reports and dashboards to be displayed based on the data analyzed by the computing environment 100. This module may allow for the customization of report formats, inclusion of specific data points, and application of filters to meet the reporting needs of different stakeholders, thereby supporting informed decision-making and strategic planning.

In operation, an end user may access the device 150 via a web browser, dedicated application, or through a secure network connection, depending on the deployment and accessibility options provided by the computing environment 100. Once connected, the end user may interact with the computing environment 100 through the user interface module 152, entering data, selecting parameters for analysis, and navigating through the system's various features and tools. The end user may also utilize the reporting module 154 to generate customized reports and dashboards, selecting specific assets for analysis, defining the scope of the rationalization review, and choosing the format and content of the output. This interactive process allows the end user to leverage the computing environment 100 for data-driven decision-making, optimizing the organization's technology asset portfolio based on detailed insights and recommendations provided by the system.

When an end user accesses the AI Powered Asset Rationalization Computing System, identified as computing environment 100, through the device 150, several components within the system are engaged. The user interface module 152 provides a graphical interface that allows users to input data, adjust settings for analysis, and navigate the system's functionalities. This module is designed to make the computing environment accessible to a broad range of users, facilitating interaction with the asset rationalization process.

The reporting module 154 processes users' requests for specific analyses, applying selected filters and parameters to produce outputs that meet the users' requirements. This capability allows for the customization of reports, ensuring that the insights and recommendations generated by the computing environment match the users' unique decision-making processes. Simultaneously, the input module 112 collects data from users and other sources, serving as the entry point for information that will be analyzed. The analysis module 114 processes this data, using neural networks, generative AI models, and other analytical tools to extract meaningful patterns and insights. These insights inform the recommendations made by the rationalization module 116, which suggests actions to optimize the organization's technology asset portfolio based on the analysis. Lastly, the output module 118 is responsible for presenting the results of the analysis and rationalization process to the user, producing detailed reports, diagrams, and potentially AI-enabled videos that explain the recommended steps for asset rationalization.

The components of the computing environment 100 work together to enable end users to effectively engage with the system, supporting an organized approach to asset rationalization. From the initial data input to the final presentation of actionable insights, the system is designed to assist in the strategic management of technology assets.

The industry benchmarking system 160 within the computing environment 100 may serve as a specialized module or external platform that provides access to industry-wide data, standards, and performance metrics relevant to technology asset management and rationalization. This system may be designed to aggregate and analyze benchmarking data from various sources, including market research firms, industry associations, and peer organizations. The purpose of the industry benchmarking system 160 is to offer a comparative framework that enables the computing environment 100 to evaluate an organization's technology assets against prevailing industry norms and best practices.

By integrating with the industry benchmarking system 160, the computing environment 100 may advantageously gain insights into competitive positioning, identify areas for improvement, and uncover opportunities for innovation within the organization's technology asset portfolio. The system may provide metrics on asset utilization, cost efficiency, maintenance practices, and technological advancements, among other aspects. This benchmarking data may be utilized by the analysis module 114 and the rationalization module 116 to inform their processes, ensuring that the recommendations for asset rationalization are not only based on internal data but also reflect broader industry trends and standards.

### Exemplary Computer-Implemented Methods

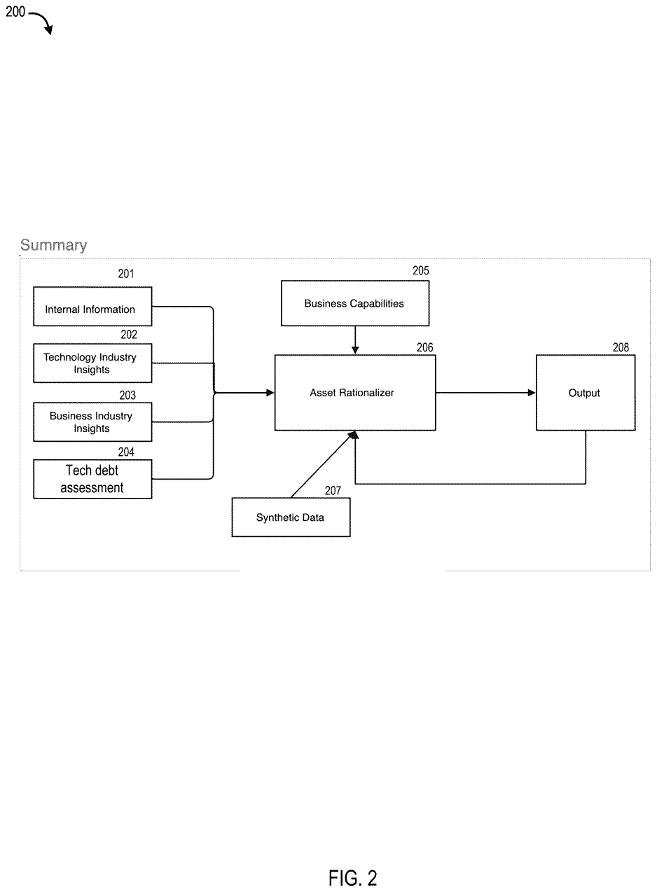

FIG. 2 depicts a flow diagram of a computer-implemented method 200 for optimizing business processes and decisions related to technology assets, according to some aspects. The method 200 may include processing internal information (block 201), which constitutes the base input for the process. The method 200 may include integrating technology industry insights (block 202), providing a broader context from the technology industry perspective. Additionally, the method 200 may include incorporating business industry insights (block 203), offering a view from the specific industry within which the business operates.

Further, the method 200 may involve evaluating tech debt via the techniques discussed in U.S. patent application Ser. No. 18/889,583, entitled “ANALYSIS AND CLASSIFICATION METHODS AND SYSTEMS FOR ASSESSING, IDENTIFYING, AND TRACKING TECHNICAL DEBT IN ORGANIZATIONS”; filed on Sep. 19, 2024 and herein incorporated by reference in its entirety, for all purposes (block 204), acknowledging the potential impact of technical debt on the business assets.

The method 200 may include examining business capabilities (block 205) as an essential factor in the rationalization process. The method 200 may include performing asset rationalization (block 206), where the combined inputs from blocks 201, 202, 203, and 204 are analyzed to make decisions regarding the business assets. To augment the input data, the method 200 may include generating or using synthetic data (block 207), which serves as additional information for the asset rationalization process. The method 200 may include generating an output (block 208) that represents the optimized business strategy or decisions regarding the management of the technology assets, taking into account all the previous inputs and analyses.

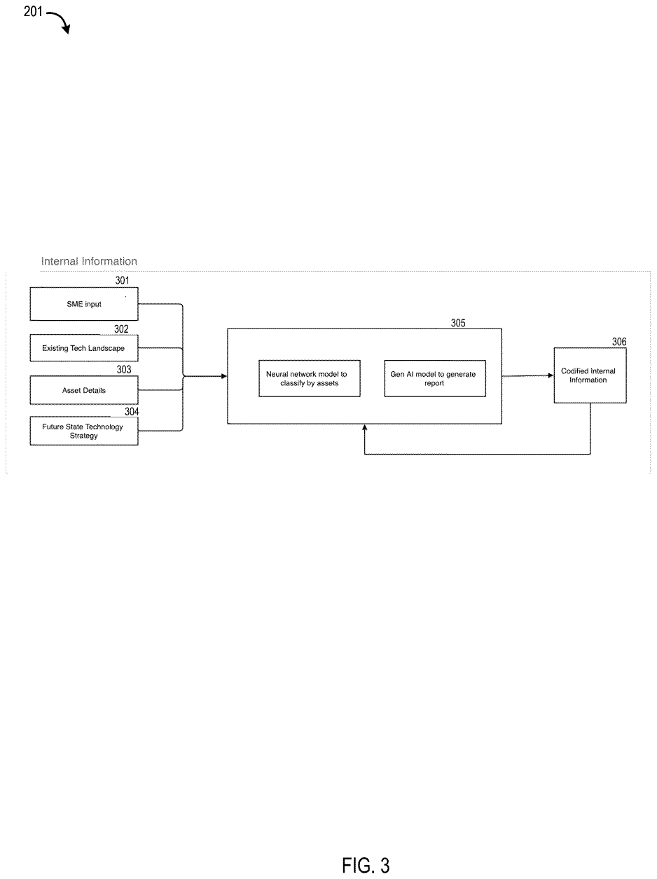

FIG. 3 depicts a computer-implemented method 201 for processing and generating reports based on internal information using artificial intelligence, according to some aspects. The method 201 may include receiving input from subject matter experts (SME) (block 301). The method 201 may also include assessing the existing technology landscape (block 302) and obtaining asset details (block 303). Additionally, the method 201 may involve considering a future state technology strategy (block 304). The gathered internal information from blocks 301, 302, 303, and 304 is then fed into a neural network model to classify by assets (block 305). Following the classification, the method 201 includes the generation of a report by an AI model (block 306), resulting in codified internal information.

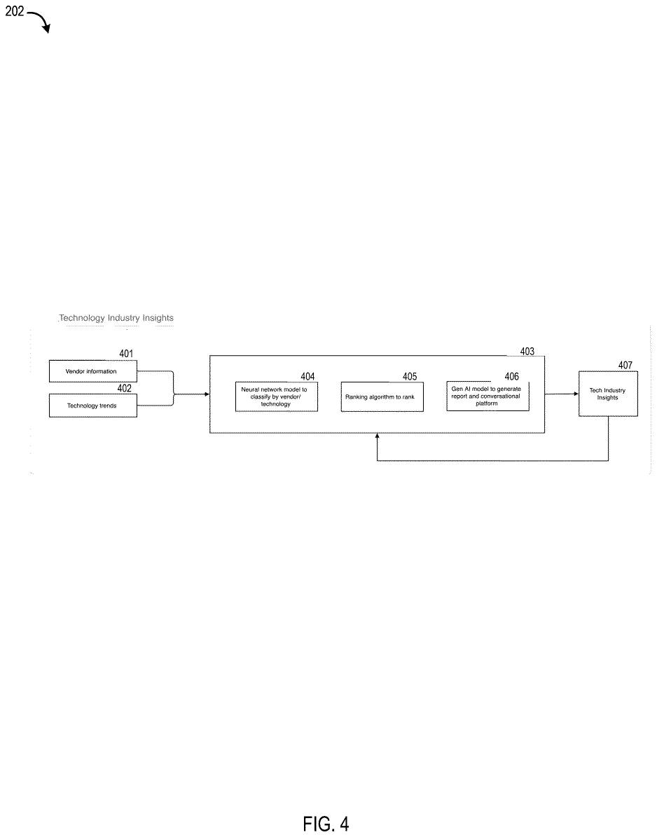

FIG. 4 depicts a computer-implemented method 202 for providing technology industry insights, according to some aspects. The method 202 may include obtaining vendor information (block 401). The method 202 may also include obtaining technology trends (block 402). Additionally, the method 202 may include utilizing a neural network model to classify by vendor and/or technology (block 404). Furthermore, the method 202 may include employing a ranking algorithm to rank (block 405). The method 202 may also include deploying a GAN model to generate report and conversational platform (block 406). Finally, the method 202 may include producing technology industry insights (block 407).

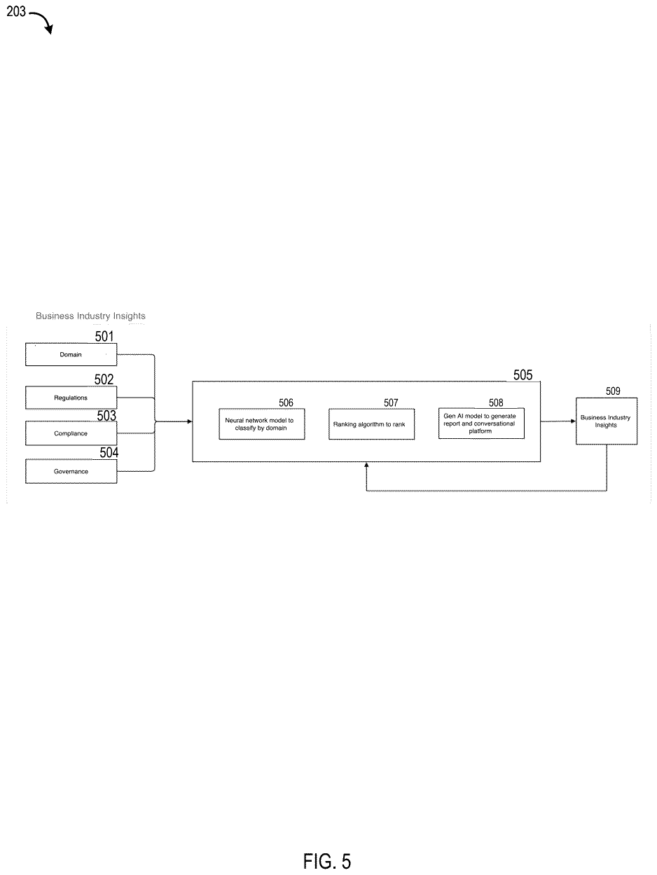

FIG. 5 depicts a computer-implemented method 203 for providing business industry insights, according to some aspects. The method 203 may include identifying a domain (block 501). The method 203 may further include considering regulations related to the domain (block 502), ensuring compliance within the domain (block 503), and addressing governance within the domain (block 504). The method 203 may also include utilizing a neural network model to classify by domain (block 506), applying a ranking algorithm to rank information (block 507), and employing a general AI model to generate reports and conversational platform interaction (block 508). Ultimately, the method 203 may culminate in the generation of business industry insights (block 509).

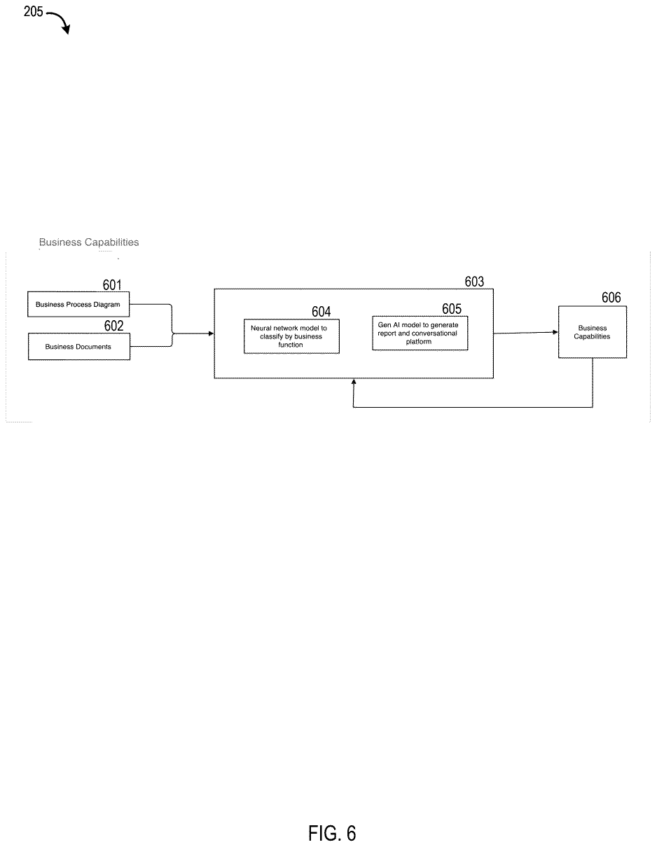

FIG. 6 depicts a computer-implemented method 205 for enhancing business capabilities, according to some aspects. The method 205 may include developing a business process diagram (block 601). Additionally, the method 205 may include creating business documents (block 602). The method 205 may further include employing a neural network model to classify by business function (block 604). Furthermore, the method 205 may incorporate generating an AI model to generate a report and conversational platform (block 605). Finally, the method 205 may conclude with defining business capabilities (block 606).

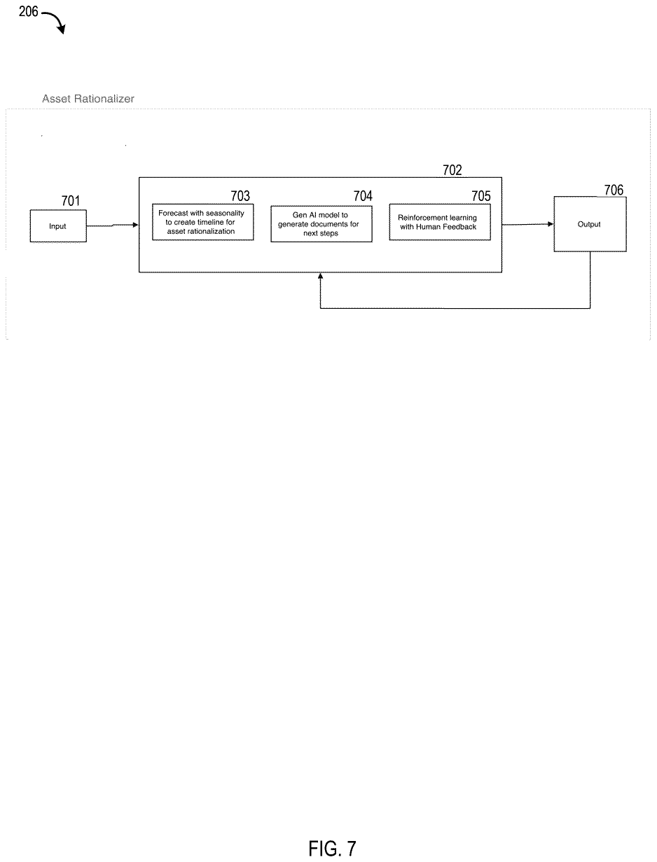

FIG. 7 depicts a computer-implemented method 206 for asset rationalization, according to some aspects. The method 206 may include receiving an input (block 701). The method 206 may include forecasting with seasonality to create timeline for asset rationalization (block 703). The method 206 may include generating an AI model to generate documents for next steps (block 704). Additionally, the method 206 may include implementing reinforcement learning with human feedback (block 705). Finally, the method 206 may result in an output (block 706).

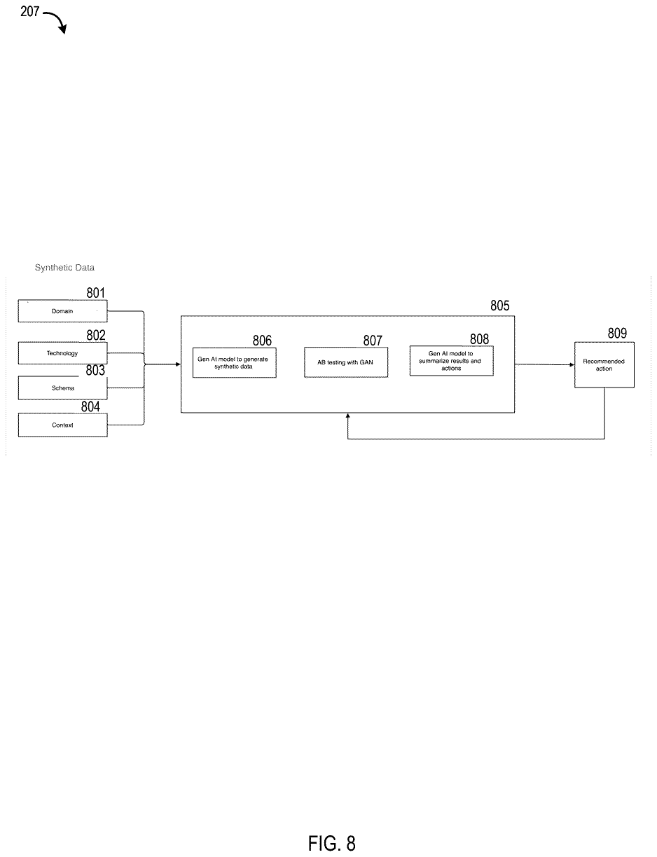

FIG. 8 depicts a computer-implemented method for generating and utilizing synthetic data, according to some aspects. The method 207 may include establishing the context for synthetic data generation by selecting a domain (block 801). Additionally, the method 207 may involve choosing the appropriate technology to be used in the synthetic data generation process (block 802). The method 207 may also include defining the schema that will be used for the synthetic data (block 803), as well as considering the contextual information that will inform the synthetic data generation (block 804). The method 207 further includes employing a generative adversarial network (GAN) model to generate synthetic data (block 806). This process is driven by the previously determined domain, technology, schema, and context. Subsequent to the synthetic data generation, the method 207 comprises conducting A/B testing with the GAN to evaluate its effectiveness (block 807). Following this, the method 207 may include using another GAN model to summarize results and decisions based on the A/B testing (block 808). The final step in the method 207 involves recommending actions based on the outcomes of the summarized results and decisions (block 809). This step translates the findings from the GAN models into actionable insights.

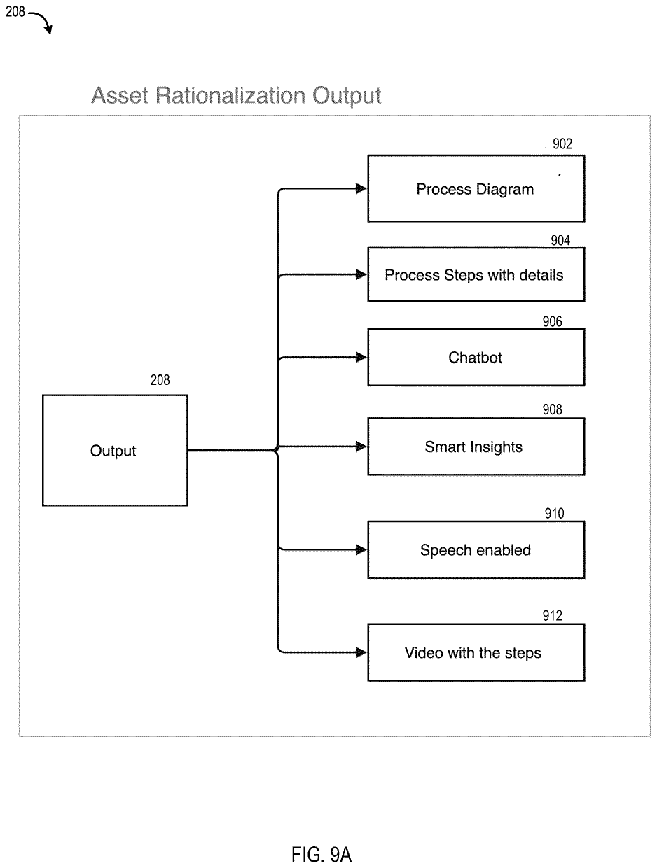

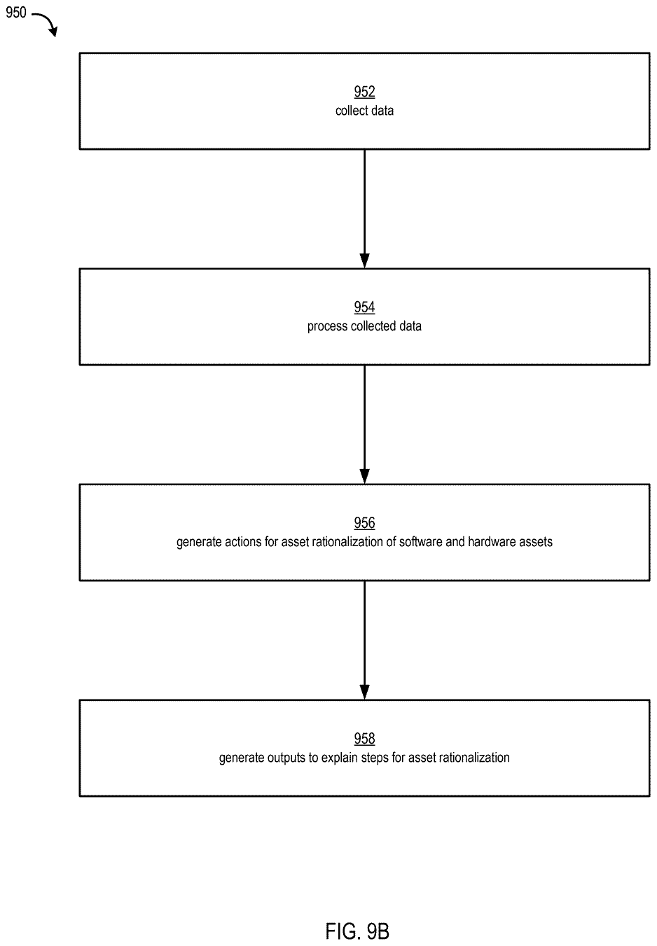

FIG. 9A depicts an output related to a computer-implemented method for asset rationalization, according to some aspects. The output may include a process diagram (block 902). The method may additionally include process steps with details (block 904). Furthermore, the method may encompass integrating a chatbot (block 906). The method may also provide smart insights (block 908). Another aspect of the method may involve enabling speech (block 910). Lastly, the method may offer a video with the steps (block 912).

At block 902, the specific output may be a process diagram. This diagram visually represents the steps involved in the asset rationalization process, illustrating the flow from data collection through analysis to the generation of rationalization actions. From a technical perspective, generating this process diagram involves several steps. Initially, the system aggregates data from its analyses and recommendations, as processed by the analysis module 114 and the rationalization module 116. Using this data, a diagramming tool or module within the output module 118 constructs a visual representation. This tool may utilize predefined templates and visualization libraries to map out the process steps, decision points, and outcomes in a clear and structured manner. The process diagram is designed to provide stakeholders with an intuitive understanding of the asset rationalization workflow, enabling them to grasp the sequence of actions and their interdependencies. The generation of this diagram relies on the system's ability to interpret and organize complex data into a coherent visual format. This may involve algorithms that can identify key phases in the rationalization process, categorize actions based on their nature (e.g., analysis, decision-making, implementation), and determine the logical flow between these actions. Additionally, the diagramming tool may incorporate user input or preferences to customize the appearance and level of detail in the diagram, ensuring that the output is tailored to the needs of the audience. The final process diagram is then rendered as an image or interactive visualization, which can be included in the detailed reports generated by the output module 118 or presented separately to stakeholders for review and discussion.

At block 904, the specific output includes process steps with details. This output provides a detailed breakdown of each step involved in the asset rationalization process, including the actions to be taken, the data analyzed, and the rationale behind each decision. Technically, generating these detailed process steps involves extracting insights and recommendations from the analysis module 114 and the rationalization module 116, which process multi-source data using AI and machine learning algorithms. The system then formats this information into a structured document or digital content, which may involve natural language generation (NLG) techniques to articulate the steps in a clear and comprehensible manner. This output is designed to guide stakeholders through the asset rationalization process, offering a granular view of the activities and considerations at each stage.

The chatbot module 906 integrates a chatbot into the system, providing an interactive interface for users to ask questions and receive information related to asset rationalization. The chatbot is developed using natural language processing (NLP) and machine learning algorithms that enable it to understand user queries and fetch relevant information from the system's database or the analysis and rationalization modules. The chatbot may be trained on a dataset of common questions and responses to ensure accurate and helpful interactions with users.

At block 908, smart insights are generated, offering data-driven recommendations and observations derived from the system's analysis. These insights are produced by applying advanced analytics and AI models to the collected data, identifying patterns, trends, and anomalies that inform the rationalization process. The system may use visualization tools and data summarization techniques to present these insights in an accessible format, such as interactive dashboards or infographics, enabling stakeholders to quickly grasp key findings and make informed decisions.

Enabling speech at block 910 involves incorporating speech recognition and text-to-speech (TTS) capabilities into the system, allowing users to interact with the system using voice commands and receive auditory responses. This feature is implemented using speech processing technologies that convert spoken language into text for the system to process and then synthesize the system's responses into spoken words. This functionality enhances accessibility and convenience for users, particularly in hands-free or mobile contexts.

Lastly, at block 912, a video with the steps is offered as an output, providing a visual and auditory narrative of the asset rationalization process. This video is created using video production software or modules within the system that combine text, images, animations, and voiceover to illustrate the process steps and key insights. The content for the video is derived from the detailed process steps and smart insights generated by the system, with scripts and storyboards developed to ensure clarity and engagement. The video serves as an educational and communication tool, helping to disseminate the rationale and recommendations of the asset rationalization process to a broad audience in an engaging format.

In relation to FIG. 2, the described output components may relate to the reported findings and recommended actions to manage asset rationalization and technical debt reduction. Specifically, these output components could be the end results after executing the steps such as receiving inputs, analyzing data, generating reports, forecasting timelines, and ranking technology options. Block 208 in FIG. 2 indicates forecasting timelines for asset rationalization which is directly associated with the asset rationalization output in FIG. 9A, demonstrating how inputs and analytical processes contribute to tangible outputs that aid in decision-making and strategy formulation.

The elements 201-208 depicted throughout FIGS. 3-9A illustrate a detailed breakdown of the processes involved in the computing environment 100's method for optimizing business processes and decisions related to technology assets. Each figure represents a step in the computer-implemented method for assessing and rationalizing technical debt, showcasing how the system leverages artificial intelligence and machine learning to process multi-source data and generate rationalization actions for both software and hardware assets. Starting with FIG. 3, which corresponds to block 201, the method begins by processing internal information. This step serves as the foundational input for the entire rationalization process, ensuring that the system has access to relevant organizational data. As the method progresses to FIG. 4 (block 202), it integrates technology industry insights, adding a broader context from the technology industry perspective. This inclusion of external data enriches the system's analysis, providing a more view of the technology landscape. FIG. 5 (block 203) further expands the system's data sources by incorporating business industry insights, offering a view from the specific industry within which the business operates. This step ensures that the system's recommendations are not only technically sound but also aligned with industry standards and practices. Moving to FIG. 6 (block 203), the system evaluates business capabilities (block 205) highlighting the importance of understanding the organization's operational strengths and weaknesses in the rationalization process. This understanding aids in tailoring the system's recommendations to the organization's unique context. FIG. 7 (element 206) depicts the actual asset rationalization step, where the combined inputs from the previous steps are analyzed to make informed decisions regarding the business assets. To augment the input data, FIG. 8 (block 207) introduces the generation or use of synthetic data, providing additional information for the asset rationalization process. This step enhances the system's ability to test and validate its recommendations under various scenarios. Finally, FIG. 9A (block 208) showcases the generation of outputs, including detailed reports, process diagrams, and AI-enabled videos, which explain the steps for asset rationalization. These outputs serve as the tangible results of the system's analysis, offering clear and actionable insights for stakeholders. Together, these figures and their corresponding elements form a cohesive logical flow of the computing environment 100's method for assessing and rationalizing technical debt. By detailing each step of the process across multiple figures, the linkage between elements 201-208 and FIGS. 3-9B demonstrates the system's thorough approach to leveraging AI and machine learning for data-driven decision-making in asset rationalization.

FIG. 9B depicts a computer-implemented method 950 for assessing and rationalizing technical debt, according to some aspects. This method leverages an approach that combines data collection from diverse sources, advanced artificial intelligence (AI) analysis, and the generation of actionable insights for asset rationalization. The method 950 is designed to streamline the process of identifying, quantifying, and addressing technical debt, thereby facilitating more informed decision-making and enhancing the efficiency and reliability of software and hardware assets management. The method 950 may be performed by the computing environment 100 of FIG. 1, for example.

The method 950 may include collecting data from multiple sources including internal organization information, technology and business industry insights, previous technical debt assessments, and business capabilities (block 952). This step involves gathering a wide array of data that provides a holistic view of the organization's technical landscape and the broader industry context. The collected data serves as the foundation for the subsequent analysis, ensuring that the recommendations for asset rationalization are well-informed and relevant. For instance, internal organization information can reveal the current state of technical debt, while insights from the technology and business industry can highlight emerging trends and best practices.

The method 950 may include processing the collected data using a combination of neural networks, generative artificial intelligence models, deep learning algorithms, and reinforcement learning with human feedback (block 954). This analysis leverages the power of AI to sift through vast amounts of data, identifying patterns, trends, and insights that might not be apparent through manual analysis. The use of neural networks and generative AI models facilitates a deep understanding of the data, while reinforcement learning with human feedback allows for the refinement of the analysis based on expert input and real-world outcomes. This step is crucial for generating accurate and actionable recommendations for asset rationalization.

The method 950 may include generating one or more actions for asset rationalization of software and hardware assets based on the processing (block 956). This involves identifying specific steps that can be taken to address technical debt, such as updating, replacing, or retiring outdated or inefficient assets. The recommendations are tailored to the organization's unique context and needs, informed by the analysis conducted in the previous step. This targeted approach ensures that the actions for asset rationalization are practical, achievable, and aligned with the organization's strategic objectives.

The method 950 may include generating outputs including detailed reports, process diagrams, and artificial intelligence-enabled videos to explain one or more steps for asset rationalization (block 958). These outputs provide a clear and accessible way to communicate the findings and recommendations to stakeholders across the organization. Detailed reports offer in-depth analysis and rationale for the proposed actions, while process diagrams and AI-enabled videos facilitate understanding and engagement with the recommendations. This communication strategy ensures that the insights generated by the method are effectively translated into actionable strategies for managing technical debt.

The method 950 may include interacting with a chatbot for queries related to the actions for asset rationalization (block 960). This feature provides a user-friendly interface for stakeholders to ask questions and seek clarification about the recommended actions for asset rationalization. The chatbot can offer instant responses, guiding users through the rationale behind specific recommendations and providing additional information as needed. This interactive tool enhances the accessibility of the method's insights, ensuring that stakeholders can easily engage with and understand the recommendations.

The method 950 may include using a smart visualization tool for interactive exploration of the actions. This tool allows stakeholders to visually explore the recommended actions for asset rationalization, offering an intuitive and engaging way to understand the implications of different strategies. Users can interact with the visualizations to drill down into specific recommendations, compare options, and assess the potential impact of various actions. This interactive exploration facilitates a deeper understanding of the recommendations, empowering stakeholders to make informed decisions about asset rationalization.

The method 950 may include employing adversarial networks for A/B testing to validate frameworks. This involves using AI to simulate different scenarios and compare the outcomes of various asset rationalization strategies. Adversarial networks can generate synthetic data that mimics real-world conditions, allowing for robust testing of the proposed frameworks. This A/B testing approach helps to validate the effectiveness and efficiency of the recommendations, ensuring that the chosen strategies are likely to achieve the desired outcomes in terms of reducing technical debt and enhancing asset performance.

The method 950 may include using synthetic data to test an effectiveness and efficiency of different models for asset rationalization. Synthetic data, generated through AI techniques, can simulate a wide range of scenarios and conditions, providing a valuable resource for testing the proposed models. This approach allows for the evaluation of different strategies in a controlled environment, identifying the most effective and efficient models for asset rationalization. By leveraging synthetic data, the method can refine its recommendations, ensuring that they are based on robust evidence and are likely to deliver tangible benefits.

The method 950 may include employing specific algorithms including Long Short-Term Memory (LSTM) and/or Prophet for forecasting with seasonality to predict timelines for asset rationalization and technical debt reduction. These algorithms are particularly suited to processing time-series data, enabling the method to forecast future trends and patterns in technical debt accumulation and reduction. By incorporating seasonality and other temporal factors, LSTM and Prophet provide nuanced predictions that can inform the timing and prioritization of asset rationalization actions. This predictive capability enhances the strategic value of the method's recommendations, helping organizations to plan effectively for technical debt management.

The method 950 may include collecting data on business processes as part of the multiple sources of data. This involves gathering detailed information about the organization's operational workflows and procedures, adding another layer of context to the analysis. Understanding business processes is crucial for identifying inefficiencies and areas where technical debt may be impacting performance. This data enriches the analysis, ensuring that the recommendations for asset rationalization are aligned with operational realities and can lead to meaningful improvements in business processes.

### Exemplary Language Model Architecture

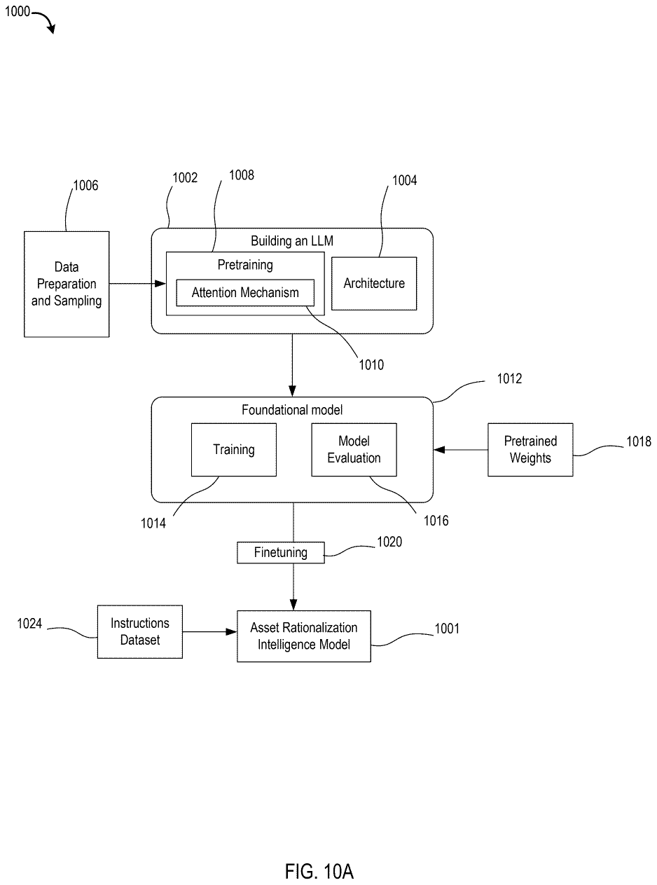

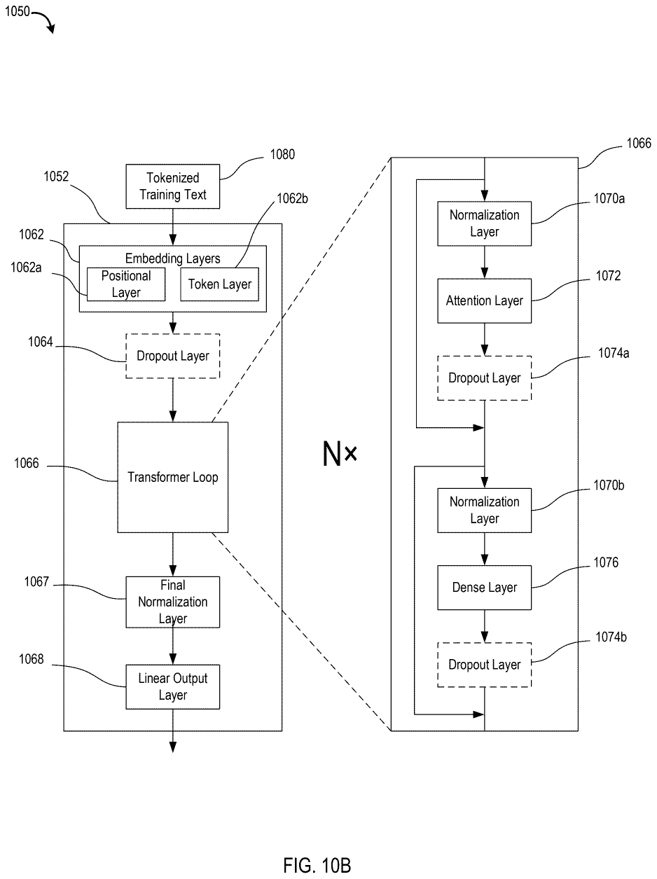

FIG. 10A depicts a block-flow diagram of a computer-implemented method 1000 for training and/or operating a language model. The block-flow structure provides a high-level overview of steps involved in setting up, training, and utilizing a language model. The method 1000 may include several components and processes, starting with Data Preparation and Sampling (block 1006) which feeds into the Pretraining section (block 1008) of Building an LLM (block 1004). Within the Pretraining section, there is an Attention Mechanism and Architecture. From the Pretraining, the flow moves to a Foundational model (block 1010) which branches into two main components: Model Training (block 1014) and Model Evaluation (block 1012). These two components represent iterative steps in the model development, as indicated by a feedback loop from Model Evaluation back to Pretrained Weights (block 1018), wherein the evaluation may lead to adjustments in the weights used for training. Once the foundational model has been established, the process may continue with Finetuning (block 1020), wherein further refinement of the model's parameters is performed to enhance its performance or adapt it to specific tasks. Finally, this refined model flows into an Asset Rationalization Intelligence Model (block 1001), influenced by an Instructions Dataset (block 1024), which indicates that the model's operation can be directed or influenced by specific instructions.

Training data for training in the method 100 may encompass a wide range of information relevant to the assessment and rationalization of technical debt and technology assets within an organization. This data serves as the foundation for the model to learn patterns, relationships, and insights that are critical for making informed decisions regarding asset rationalization. The training data may include internal organizational data, such as data related to the organization's internal processes, technology infrastructure, and existing technical debt. This could include documentation on IT systems, software and hardware inventories, and records of past technical debt assessments. The training data may also include information from external sources that provides context about the latest trends, best practices, and benchmarks in technology and the specific industry the organization operates in. This could include market research reports, industry whitepapers, and insights from technology vendors. The training data may include historical data on the organization's previous efforts to identify, quantify, and address technical debt. This could include reports detailing identified issues, actions taken, outcomes achieved, and lessons learned. The training data may include information on the organization's business functions, processes, and capabilities. This could include information on how technology assets support various business operations and strategic objectives. The training data may include artificially generated data that simulates various scenarios and conditions related to technical debt and asset rationalization. This data can be used to augment the training dataset, especially in areas where real data may be limited or sensitive. The training process may involve preprocessing this data to ensure it is in a format suitable for analysis, followed by the application of machine learning techniques, including neural networks, deep learning algorithms, and reinforcement learning with human feedback. The attention mechanism within the pretraining section allows the model to focus on the most relevant features of the data, enhancing its ability to extract meaningful insights.

FIG. 10B illustrates a neural network-based model architecture for processing and analyzing data related to asset rationalization (block 1052). The process begins with data collection (block 1080) which is then passed through preprocessing layers, specifically a data normalization layer (block 1062a) and a feature extraction layer (block 1062b). These layers are followed by a dropout layer (block 1064) to prevent overfitting. The core of the architecture is the neural network loop (block 1066), iterated N times, where N is a positive integer. Each iteration consists of a normalization layer (block 1070a), followed by an attention layer (block 1072) with its own dropout layer (block 1074a), another normalization layer (block 1070b), a dense layer (block 1076), and another dropout layer (block 1074b). The process concludes with a final normalization layer (block 1067) and a linear output layer (block 1068), producing the final output from the neural network-based model for asset rationalization.

This architecture is designed to handle and analyze data for identifying and managing technology assets efficiently. Initially, the collected data is processed through preprocessing layers, including normalization and feature extraction layers, which help the model understand the significance of each data point within the context of asset rationalization. The dropout layers introduced after the preprocessing layers and within the neural network loop serve to prevent overfitting, ensuring the model generalizes better to new, unseen data. The neural network loop, iterated N times, is where the bulk of the analysis happens, allowing the model to focus on different parts of the input data to better understand the relationships between various factors contributing to asset decisions. The final normalization layer ensures that the data is normalized before passing it to the linear output layer, which produces the final output of the model. This output can then be used for various tasks related to the optimization of business processes and technology asset decisions, such as generating reports on asset rationalization by applications and business functions.

The model architecture depicted in FIG. 10B is designed to facilitate the asset rationalization process within organizations, focusing on making informed decisions regarding the management, updating, and eventual retirement of technology assets. This process begins with the collection and preparation of data, where a dataset encompassing information on technology assets, including software and hardware specifications, usage data, maintenance records, and any existing technical debt, is gathered. This data undergoes preprocessing, which involves normalization to ensure consistency across the dataset and feature extraction to identify the most relevant attributes for the analysis.

Following data preparation, the model enters the building and pretraining phase. During this phase, the model is trained to recognize basic patterns and relationships within the data that are pertinent to asset performance and lifecycle. The architecture's attention mechanism plays a role here, enabling the model to concentrate on the most significant features of the data, thereby enhancing its learning efficiency.

The neural network loop is then iterated multiple times, with each iteration designed to refine the model's understanding and analytical capabilities. This iterative process includes several layers: normalization layers ensure data stability, attention layers focus on important features, dense layers learn non-linear relationships, and dropout layers prevent the model from overfitting. After completing these iterations, the model is evaluated for its predictive accuracy and ability to make rationalization recommendations. Based on this evaluation, the model undergoes finetuning with more specific data, further enhancing its precision in assessing and recommending asset rationalization actions.

Once the model is trained, finetuned, and deemed ready, it is deployed within the organization's IT infrastructure, where it begins its operational phase. In this phase, the model receives data on technology assets and applies its learned patterns and relationships to analyze the current state of these assets. It identifies which assets may require updates, replacements, or retirement based on various factors, including performance metrics, maintenance costs, and their alignment with the organization's future technology strategies.

The model then generates detailed reports and insights on asset rationalization, offering actionable recommendations for decision-makers. These reports enable effective planning and implementation of asset management strategies. Moreover, the model is designed to engage in continuous learning through reinforcement learning and human feedback mechanisms. As it receives feedback on the outcomes of its recommendations, it adjusts its analysis to better align with organizational goals and the realities of asset performance, ensuring that its recommendations remain relevant and valuable over time. This architecture thus supports a dynamic, data-driven approach to asset rationalization, allowing organizations to optimize their technology asset portfolios efficiently and effectively.

An example of the type of data that would be used to train the model for asset rationalization could include various attributes related to technology assets such as software and hardware specifications, usage statistics, maintenance history, and performance metrics. Below is a simplified JSON representation of such data for a hypothetical software asset:

```
‘‘‘json
{
  “assetId”: “SW12345”,
  “assetType”: “Software”,
  “assetName”: “EnterpriseResourcePlanningSystem”,
  “specifications”: {
    “version”: “10.2”,
    “releaseDate″: “2019-04-15”,
    “supportedPlatforms”: [“Windows″, “Linux”],
    “endOfLife”: “2024-04-15”
  },
  “usageStatistics”: {
    “dailyActiveUsers”: 320,
    “averageSessionDuration”: “2 hours”,
    “criticalBusinessFunction”: true
  },
  “maintenanceHistory”: [
    {
      “date”: “2020-06-20”,
      “updateType”: “Security Patch”,
      “version”: “10.2.1”
    },
    {
      “date”: “2021-03-15”,
      “updateType”: “Feature Update”,
      “version”: “10.3”
    }
  ],
  “performanceMetrics”: {
    “uptimePercentage”: 99.8,
    “responseTime”: “200 ms”,
    “errorRate”: “0.01%”
  },
  “technicalDebt”: {
    “identifiedIssues”: 12,
    “estimatedResolutionCost”: 50000,
    “impactOnBusiness”: “Moderate”
  }
}
’’’
```

This JSON snippet provides a structured view of the data related to a specific software asset, including its specifications, usage statistics, maintenance history, performance metrics, and associated technical debt. Such data is crucial for training the model to understand the characteristics of technology assets, their operational performance, and the implications of technical debt. By analyzing this data, the model can learn to identify patterns and make informed recommendations for asset rationalization, such as updating, replacing, or retiring assets based on their performance, maintenance costs, and alignment with future technology strategies.

In the provided JSON example data, various aspects are integral to training the model for asset rationalization, each offering insights into different dimensions of technology asset management. The specifications of the asset, including its version, release date, supported platforms, and end-of-life information, are critical for understanding the lifecycle and technological relevance of the asset. The model uses this information to assess whether an asset is approaching obsolescence or if it remains a viable part of the technology stack, guiding decisions on updates or replacements.

Usage statistics, such as daily active users, average session duration, and the asset's role in critical business functions, inform the model about the asset's utilization and importance within the organization. This data helps the model prioritize assets based on their impact on business operations, identifying underutilized assets or those not critical to core functions for potential rationalization.

The maintenance history, detailing updates and patches, offers a window into the asset's reliability and the organization's commitment to maintaining it. By analyzing patterns in the maintenance history, the model learns to identify assets that may require disproportionate effort to maintain versus their value to the organization, suggesting more efficient alternatives.

Performance metrics, including uptime percentage, response time, and error rate, directly reflect the asset's operational efficiency. The model evaluates these metrics to determine if an asset meets the current performance standards and anticipates future requirements, flagging assets that fall short for potential updates or decommissioning.

Lastly, information on technical debt, such as identified issues, estimated resolution cost, and its impact on business, allows the model to consider the hidden costs of maintaining the asset. The model integrates this data to make informed recommendations, balancing the direct costs of updates or replacements against the indirect costs of continuing to operate with existing technical debt.

By training on these aspects, the model develops a nuanced understanding of asset rationalization, learning to make recommendations that optimize the technology asset portfolio based on data analysis. This process involves iterative learning, where the model refines its predictions and recommendations based on a holistic view of each asset's specifications, usage, maintenance needs, performance, and associated technical debt, ensuring that asset rationalization decisions are data-driven and aligned with strategic business objectives.

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system for assessing and rationalizing technical debt, comprising: a processor; and a memory having stored thereon computer-executable instructions that, when executed, cause the computing system to: collect data from multiple sources including internal organization information, technology and business industry insights, previous technical debt assessments, and business capabilities; process the collected data using a combination of neural networks, generative artificial intelligence models, deep learning algorithms, and reinforcement learning with human feedback; generate one or more actions for asset rationalization of software and hardware assets based on the processing; and generate outputs including detailed reports, process diagrams, and artificial intelligence-enabled videos to explain one or more steps for asset rationalization.
2. The computing system of aspect 1, further comprising a chatbot for interactive queries related to the actions for asset rationalization.
3. The computing system of any of aspects 1-2, further comprising a smart visualization tool for interactive exploration of the actions.
4. The computing system of any of aspects 1-3, wherein the memory further comprises instructions for employing adversarial networks for A/B testing to validate frameworks.
5. The computing system of any of aspects 1-4, wherein the memory further comprises instructions for using synthetic data to test an effectiveness and efficiency of different models for asset rationalization.
6. The computing system of any of aspects 1-5, wherein the memory further comprises instructions for employing specific algorithms including Long Short-Term Memory (LSTM) and Prophet for forecasting with seasonality to predict timelines for asset rationalization and technical debt reduction.
7. The computing system of any of aspects 1-6, wherein the memory further comprises instructions for collecting data on business processes as part of the multiple sources of data.
8. A computer-implemented method for assessing and rationalizing technical debt, comprising: collecting data from multiple sources including internal organization information, technology and business industry insights, previous technical debt assessments, and business capabilities; processing the collected data using a combination of neural networks, generative artificial intelligence models, deep learning algorithms, and reinforcement learning with human feedback; generating one or more actions for asset rationalization of software and hardware assets based on the processing; and generating outputs including detailed reports, process diagrams, and artificial intelligence-enabled videos to explain one or more steps for asset rationalization.
9. The method of aspect 8, further comprising interacting with a chatbot for queries related to the actions for asset rationalization.
10. The method of any of aspects 8-9, further comprising using a smart visualization tool for interactive exploration of the actions.
11. The method of any of aspects 8-10, further comprising employing adversarial networks for A/B testing to validate frameworks.
12. The method of any of aspects 8-11, further comprising using synthetic data to test an effectiveness and efficiency of different models for asset rationalization.
13. The method of any of aspects 8-12, further comprising employing specific algorithms including Long Short-Term Memory (LSTM) and Prophet for forecasting with seasonality to predict timelines for asset rationalization and technical debt reduction.
14. The method of any of aspects 8-13, further comprising collecting data on business processes as part of the multiple sources of data.
15. A computer-readable medium having stored thereon instructions that when executed cause a computer to perform a method for assessing and rationalizing technical debt, the method comprising: collecting data from multiple sources including internal organization information, technology and business industry insights, previous technical debt assessments, and business capabilities; processing the collected data using a combination of neural networks, generative artificial intelligence models, deep learning algorithms, and reinforcement learning with human feedback; generating one or more actions for asset rationalization of software and hardware assets based on the processing; and generating outputs including detailed reports, process diagrams, and artificial intelligence-enabled videos to explain one or more steps for asset rationalization.
16. The computer-readable medium of aspect 15, wherein the method further comprises interacting with a chatbot for queries related to the actions for asset rationalization.
17. The computer-readable medium of any of aspects 15-16, wherein the method further comprises using a smart visualization tool for interactive exploration of the actions.
18. The computer-readable medium of any of aspects 15-17, wherein the method further comprises employing adversarial networks for A/B testing to validate frameworks.
19. The computer-readable medium of any of aspects 15-18, wherein the method further comprises using synthetic data to test an effectiveness and efficiency of different models for asset rationalization.
20. The computer-readable medium of any of aspects 15-19, wherein the method further comprises employing specific algorithms including Long Short-Term Memory (LSTM) and Prophet for forecasting with seasonality to predict timelines for asset rationalization and technical debt reduction.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112 (f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computing system for assessing and rationalizing technical debt, comprising:
a processor; and
a memory having stored thereon computer-executable instructions that, when executed, cause the computing system to:
collect data from multiple sources including internal organization information, technology and business industry insights, previous technical debt assessments, and business capabilities;
transform the collected data into a unified intermediate representation, wherein the transformation includes normalization of data formats and encoding of dependency relationships among assets;
process the unified intermediate representation using an ensemble of artificial intelligence models, neural networks, generative artificial intelligence models, deep learning algorithms, and reinforcement learning with human feedback to identify potential asset rationalization opportunities;
generate, based on the identified asset rationalization opportunities, one or more proposed asset rationalization actions corresponding to software and hardware assets;
generate a forecast of timelines for asset rationalization and technical debt reduction based on the one or more proposed asset rationalization actions;
validate the one or more proposed asset rationalization actions using adversarial networks, wherein the adversarial networks generate synthetic data;
generate one or more multimodal explanatory outputs for the proposed asset rationalization actions, wherein each multimodal explanatory output includes synchronized narrative text, detailed reports, process diagrams, and artificial intelligence-enabled; and
append each proposed asset rationalization action and its corresponding multimodal explanatory outputs to a versioned repository data structure.

2. The computing system of claim 1, further comprising a chatbot for interactive queries related to the asset rationalization actions.

3. The computing system of claim 1, further comprising a smart visualization tool for interactive exploration of the asset rationalization actions.

4. The computing system of claim 1, wherein the memory further comprises instructions for employing adversarial networks for A/B testing to validate frameworks.

5. The computing system of claim 1, wherein the memory further comprises instructions for using synthetic data to test an effectiveness and efficiency of different models for asset rationalization.

6. The computing system of claim 1, wherein the memory further comprises instructions for employing specific algorithms including Long Short-Term Memory (LSTM) and Prophet for forecasting with seasonality to predict timelines for asset rationalization and technical debt reduction.

7. The computing system of claim 1, wherein the memory further comprises instructions for collecting data on business processes as part of the multiple sources of data.

8. A computer-implemented method for assessing and rationalizing technical debt, comprising:
collecting data from multiple sources including internal organization information, technology and business industry insights, previous technical debt assessments, and business capabilities;
transforming the collected data into a unified intermediate representation, wherein the transformation includes normalization of data formats and encoding of dependency relationships among assets;
processing the unified intermediate representation using an ensemble of artificial intelligence models, neural networks, generative artificial intelligence models, deep learning algorithms, and reinforcement learning with human feedback to identify potential asset rationalization opportunities;
generating, based on the identified asset rationalization opportunities, one or more proposed asset rationalization actions corresponding to software and hardware assets;
generating a forecast of timelines for asset rationalization and technical debt reduction based on the one or more proposed asset rationalization actions;
validating the one or more proposed asset rationalization actions using adversarial networks, wherein the adversarial networks generate synthetic data;
generating one or more multimodal explanatory outputs for the proposed asset rationalization actions, wherein each multimodal explanatory output includes synchronized narrative text, detailed reports, process diagrams, and artificial intelligence-enabled; and
appending each proposed asset rationalization action and its corresponding multimodal explanatory outputs to a versioned repository data structure.

9. The method of claim 8, further comprising interacting with a chatbot for queries related to the asset rationalization actions.

10. The method of claim 8, further comprising using a smart visualization tool for interactive exploration of the asset rationalization actions.

11. The method of claim 8, further comprising employing adversarial networks for A/B testing to validate frameworks.

12. The method of claim 8, further comprising using synthetic data to test an effectiveness and efficiency of different models for asset rationalization.

13. The method of claim 8, further comprising employing specific algorithms including Long Short-Term Memory (LSTM) and Prophet for forecasting with seasonality to predict timelines for asset rationalization and technical debt reduction.

14. The method of claim 8, further comprising collecting data on business processes as part of the multiple sources of data.

15. A computer-readable medium having stored thereon instructions that when executed cause a computer to perform a method for assessing and rationalizing technical debt, the method comprising:
collecting data from multiple sources including internal organization information, technology and business industry insights, previous technical debt assessments, and business capabilities;
transforming the collected data into a unified intermediate representation, wherein the transformation includes normalization of data formats and encoding of dependency relationships among assets;
processing the unified intermediate representation using an ensemble of artificial intelligence models, neural networks, generative artificial intelligence models, deep learning algorithms, and reinforcement learning with human feedback to identify potential asset rationalization opportunities;
generating, based on the identified asset rationalization opportunities, one or more proposed asset rationalization actions corresponding to software and hardware assets;
generating a forecast of timelines for asset rationalization and technical debt reduction based on the one or more proposed asset rationalization actions;
validating the one or more proposed asset rationalization actions using adversarial networks, wherein the adversarial networks generate synthetic data;
generating one or more multimodal explanatory outputs for the proposed asset rationalization actions, wherein each multimodal explanatory output includes synchronized narrative text, detailed reports, process diagrams, and artificial intelligence-enabled; and
appending each proposed asset rationalization action and its corresponding multimodal explanatory outputs to a versioned repository data structure.

16. The computer-readable medium of claim 15, wherein the method further comprises interacting with a chatbot for queries related to the asset rationalization actions.

17. The computer-readable medium of claim 15, wherein the method further comprises using a smart visualization tool for interactive exploration of the asset rationalization actions.

18. The computer-readable medium of claim 15, wherein the method further comprises employing adversarial networks for A/B testing to validate frameworks.

19. The computer-readable medium of claim 15, wherein the method further comprises using synthetic data to test an effectiveness and efficiency of different models for asset rationalization.

20. The computer-readable medium of claim 15, wherein the method further comprises employing specific algorithms including Long Short-Term Memory (LSTM) and Prophet for forecasting with seasonality to predict timelines for asset rationalization and technical debt reduction.
